(19) United States
(12) Patent Application Publication
(10) Pub. No.: US 2007/0137930 A1
(43) Pub. Date: Jun. 21, 2007

(54) ADJUSTABLE SUPPORT AND DISPLAY SYSTEM

(76) Inventor: Jeffrey L. Harpold, Plainfield, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/612,668

(22) Filed: Dec. 19, 2006

Related U.S. Application Data
(60) Provisional application No. 60/751,683, filed on Dec. 19, 2005.

(51) Int. Cl. E04G 1/34

(52) U.S. Cl. 182/152; 182/155; 182/225

(57) ABSTRACT

An adjustable support and display system incorporates first and second assemblies that are joined at one end in a hinged arrangement. Each assembly is rectangular in shape and is supported by at least three points when the hinge arrangement is opened. Remote members of the first and second assemblies extend above the upper dimensional limit of the members of the respective assemblies that extend outwardly from the hinged end. These extensions act to provide stops to stabilize the sliding or transverse movement of any material that is placed on the support and display system.

### CROSS-REFERENCE TO RELATED APPLICATION

The present application claims the benefit of U.S. Provisional Application Ser. No. 60/751,683 filed on Dec. 19, 2005, which is hereby incorporated by reference in its entirety.

### BACKGROUND

This disclosure relates to adjustable devices that may be used to support or display objects. Such devices may be used as temporary work supports, or for a more permanent display or use.

An example of a conventional temporary work support system is a basic sawhorse, consisting of a cross-beam, often a wooden board, and a pair of brackets which hold four pieces of wood that are used as legs. While this style of sawhorse is very popular and inexpensive, it requires assembly prior to use and at least partial disassembly for storage. U.S. Pat. No. 4,113,056 to DeLorenzo discloses a foldable sawhorse using a pair of hinged stampings. Each stamping includes two legs at opposite ends with the legs connected together by upper and lower struts. Additionally, U.S. Pat. No. 5,012,893 to Kraeger discloses a folding sawhorse with a beam and three sets of folding legs that have braces attached to a bar running parallel to the sawhorse beam. The present disclosure improves upon the stability, portability, storage, and use of known support and display systems such as those previously described.

### SUMMARY

In one embodiment, there is provided a novel and improved work or material support system that can support objects securely and easily.

In another embodiment, an adjustable system can be used for a variety of support or display purposes.

Further objects, embodiments, forms, benefits, aspects, features and advantages of the present disclosure may be obtained from the description, drawings, and claims provided herein.

### DESCRIPTION OF THE DRAWINGS

FIG. 1 is a perspective view of an adjustable support and display system in accordance with one embodiment of the disclosure.

FIG. 2 is a perspective view of the system of FIG. 1, illustrating additional details.

FIG. 3 is another perspective view of the system of FIG. 1, showing other features.

FIG. 4 is a side elevational view of the system of FIG. 1, shown in one position.

FIG. 5 is perspective view of the system shown in FIG. 1, illustratively adjusted to hold a quantity of material.

FIG. 6 is a perspective view of multiple systems such as that shown in FIG. 1, illustrating an object being supported.

FIG. 7 is a perspective view of the system shown of FIG. 1, illustrating a possible use thereof.

FIG. 8 is a perspective view of the system of FIG. 1, illustrating another use.

FIG. 9 is a perspective view of the system of FIG. 1, illustrating yet another use.

FIG. 10 is a perspective view of the system of FIG. 1, illustrating still another use.

### DESCRIPTION OF THE EMBODIMENTS

For the purposes of promoting an understanding of the principles of the disclosure, reference will now be made to the embodiments illustrated in the drawings and specific language will be used to describe the same. It will nevertheless be understood that no limitation of the scope of the disclosure is thereby intended, such alterations and further modifications in the illustrated device, and such further applications of the principles of the disclosure as illustrated therein being contemplated as would normally occur to one skilled in the art to which the disclosure relates. Although one embodiment of the disclosure is shown in detail, it will be apparent to those skilled in the relevant art that some features not considered critical to the disclosure may not be shown for the sake of clarity.

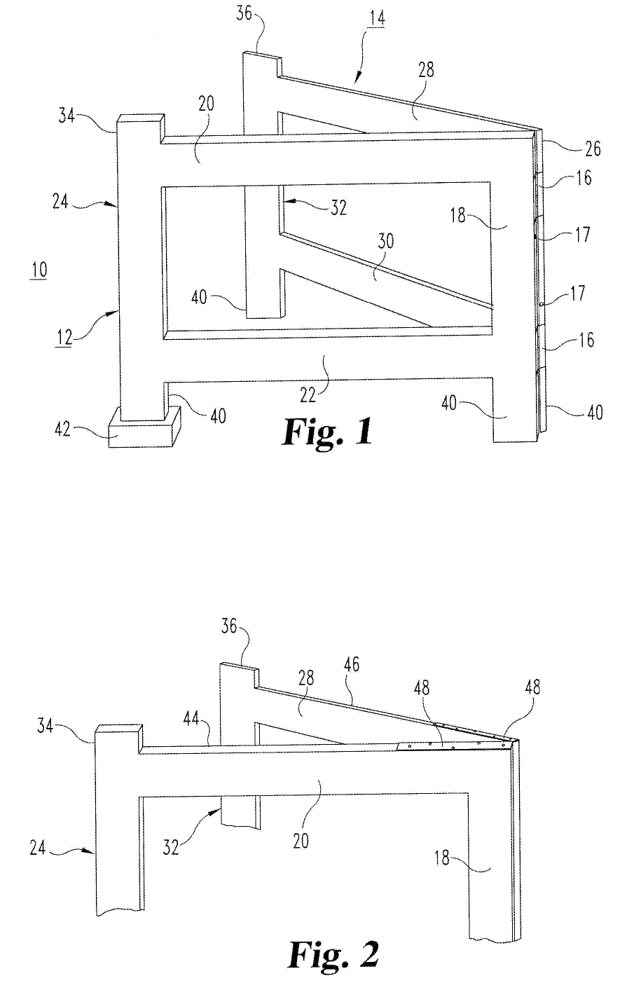

As shown in FIG. 1, in one embodiment, an adjustable support and display system 10 has a first assembly 12 and a second assembly 14 joined together by one or more connectors, shown illustratively in FIG. 1 as hinges 16. First assembly 12 is illustratively shown as incorporating a first or proximal elongated side member 18, second elongated side member 20 and third elongated side member 22, substantially parallel to each other and extending at substantially right angles from first side member 18. A fourth or distal elongated side member 24 extends at a substantially right angle to second and third members 20 and 22. Fourth member 24 is substantially parallel to first member 18. Side members 18, 20, 22, and 24 are all arranged in a substantially rectangular fashion, and all members substantially fall within a single plane. Members 18, 20, 22, and 24 may be made of individual pieces that are connected or otherwise joined together to form assembly 12, or they may be manufactured, e.g., molded or machined, as one integral piece. Members 18, 20, 22, and 24 are illustratively shown as being of substantially rectangular cross section, but other cross-sectional shapes (e.g., round) are also contemplated. Second assembly 14 is similarly constructed, incorporating a first elongated member 26, second and third elongated members 28 and 30, and a fourth elongated member 32. First member 18 of assembly 12 and first member 26 of assembly 14 are connected as described above by hinges 16. First and second assemblies 12 and 14 can be made from metal, plastic, wood, composites of any of the foregoing, or from any other relatively lightweight materials strong enough to support heavy loads. In a preferred embodiment, the assemblies are made from tubular vinyl. The materials used for the assemblies may be reinforced with agents such as fiberglass. The assemblies can be constructed or injection molded, or otherwise made as would occur to a person having ordinary skill in the art to which such products relate. System 10 can be manufactured in a variety of colors, with bright colors, such as yellow, orange, or white having the advantage of high visibility. Assemblies 12 and 14 are illustratively manufactured to be identical or mirror images to maintain low cost and to simplify manufacturing.

In the embodiment shown in FIG. 1, a detail of which is shown in FIG. 2, fourth member 24 of first assembly 12 incorporates an extension portion 34 that extends beyond the dimensional limits of second member 20. Similarly, fourth member 32 of second assembly 14 incorporates an extension portion 36 that extends beyond the dimensional limits of second member 28. As can be seen in FIG. 1 and FIG. 2, first member 18 of first assembly 12 and first member 26 of second assembly 14 do not extend beyond the dimensional limits of second members 20 and 28, respectively. Extension portions 34 and 36 are illustratively shown as being incorporated as part of fourth members 24 and 32 respectively, but they could be manufactured to extend from a part of second members 20 and 28 instead.

Extended portions 40 of first members 18 and 26 and fourth members 24 and 32 are also shown as extending beyond the dimensional limits of third members 22 and 30. Extended portions 40 illustratively act as supporting feet when system 10 is positioned as shown in FIG. 1. One foot 40 is also illustratively shown as incorporating a foot cap 42 for protection of system 10 and for added stability. Foot caps 42 may be incorporated or placed on all or as many feet 40 as are needed or desired. Foot cap 42 may be made of rubber or other suitable material.

As described above, first assembly 12 is connected to second assembly 14 via hinges 16. Hinges 16 are shown as being separate elements, but the connection between assembly 12 and assembly 14 may be a single continuous hinge, or it may be via some other form of connection, such as for example, one or more plastic welds, some form of flexible joint (interleaving or non-interleaving), or some other means that would occur to one skilled in the art. Hinges 16 may be made out of metal, plastic, composites, or other materials as would occur to a person having ordinary skill in the art. In one embodiment, the hinge and its associated pin are made from a vinyl/nylon composite. It is anticipated that the hinging or connection arrangement will extend between about 0° to substantially, although preferably less than 180°. In FIG. 1 there can be seen raised dimples or stops 17 which act to prevent the over-opening of hinge or hinges 16 in order to protect hinge 16 as well as to insure that system 10 remains stable even when fully opened.

As can be seen in FIG. 2, surface 44 of member 20 and surface 46 of member 28 incorporate anti-skid surfaces 48. Anti-skid surfaces 48 are shown as occupying an area at the end of members 20 and 28 near members 18 and 26, but anti-skid surfaces 48 may be placed anywhere along surfaces 44 and 46 as may be desired or needed. The anti-skid surfaces 48 increase the friction system 10 and any object that is placed on system 10. The anti-skid surfaces 48 can be a single strip along the entire or a substantial portion of surfaces 44 and 46, or they may comprise one or more individual patches. It is anticipated that the anti-skid surfaces 48 occupy no more than 20% of the total area of surfaces 44 and 46. The anti-skid surfaces 48 can be made integral with surfaces 44 and 46, e.g., a “roughened” spot or a chemically treated area. Surfaces 48 may also be formed by a layer of material that is affixed, such as an elastomer, felt or carpet, for example., or they can be formed by an applied coating, such as latex, for example. Other techniques for forming or constructing surfaces 48 may also be used in order to increase friction without abrading or defacing the object being placed upon system 10.

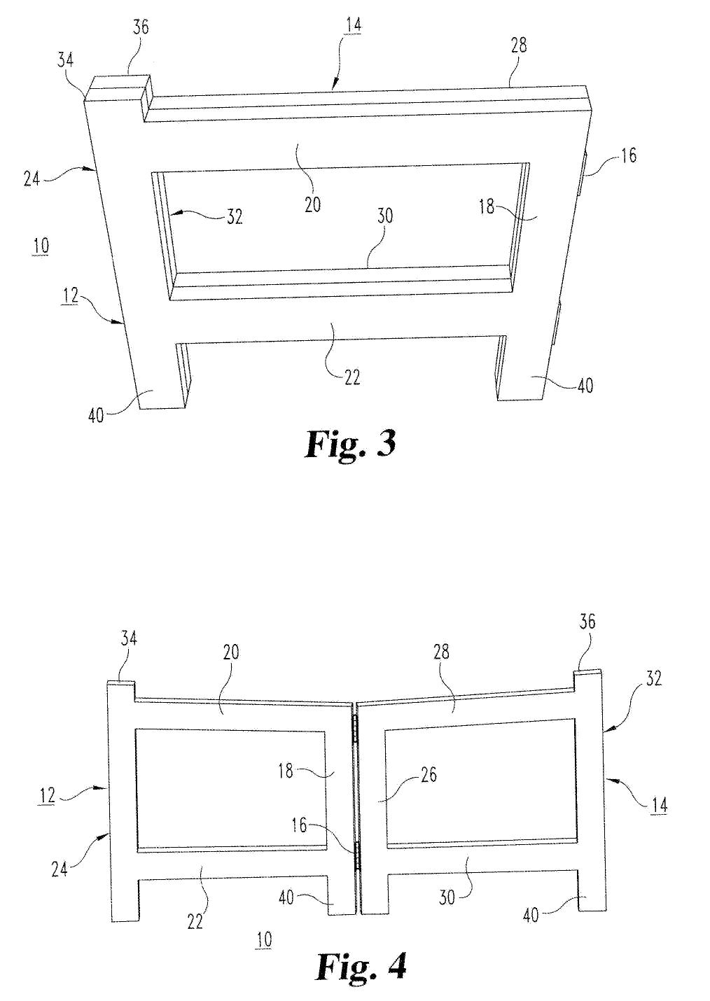

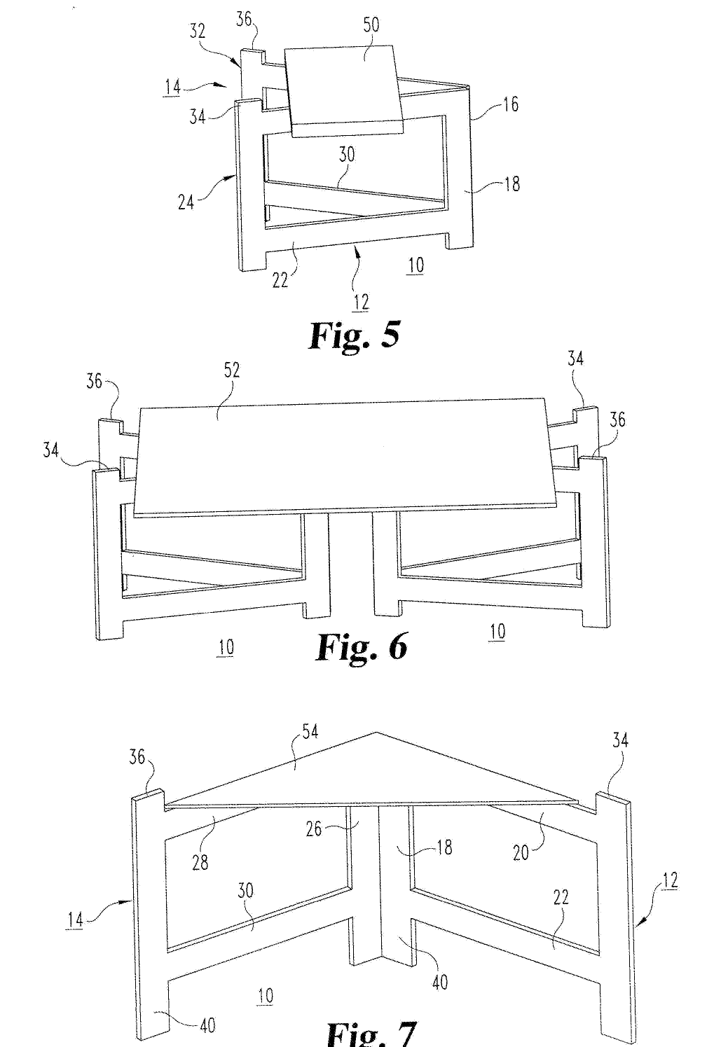

FIG. 3 shows system 10 in a collapsed or folded state for storage or transport, while FIG. 4 shows system 10 in an open state. As can be seen from FIG. 3, when first assembly 12 and second assembly 14 are identical or mirror images of one another, system 10 is easy to carry in its folded state as the open spaces match one another and provide an opening to use as a handle. To use system 10, assemblies 12 and 14 are moved apart via hinges 16, such as is shown in FIG. 4. As illustrated in FIG. 5, an object 50 may be may be placed on system 10. FIG. 5 shows system 10 opened in one position such that there is an acute angle formed between the first assembly 12 and second assembly 14. In the embodiment of FIG. 5, extended portions 34 and 36 act as stops against which object 50 may be placed such object 50 will not slide or otherwise move when work (e.g., sanding, planing, or finishing) is performed on object 50. The degree to which assemblies 12 and 14 are opened via hinges 16 will depend upon the size of object 50 that is placed on system 10, so as to maintain stability between system 10 and object 50.

The multi-purposed system 10 can be used singly or in multiple numbers. FIG. 6 illustrates system 10 being used in a paired arrangement in order to hold and support a large object 52, such as a large piece of plywood, for example. The extended portions 34 and 36 of each unit of system 10 can substantially embrace object 52 from each end, thereby minimizing slippage of object 52. As can be seen in FIG. 6, the placement of each unit of system 10 provides significant support for object 52 along a substantial part of its entire length, thereby preventing bowing or sagging of object 52, an advantage that would not be possible with a pair of conventional sawhorses, for example.

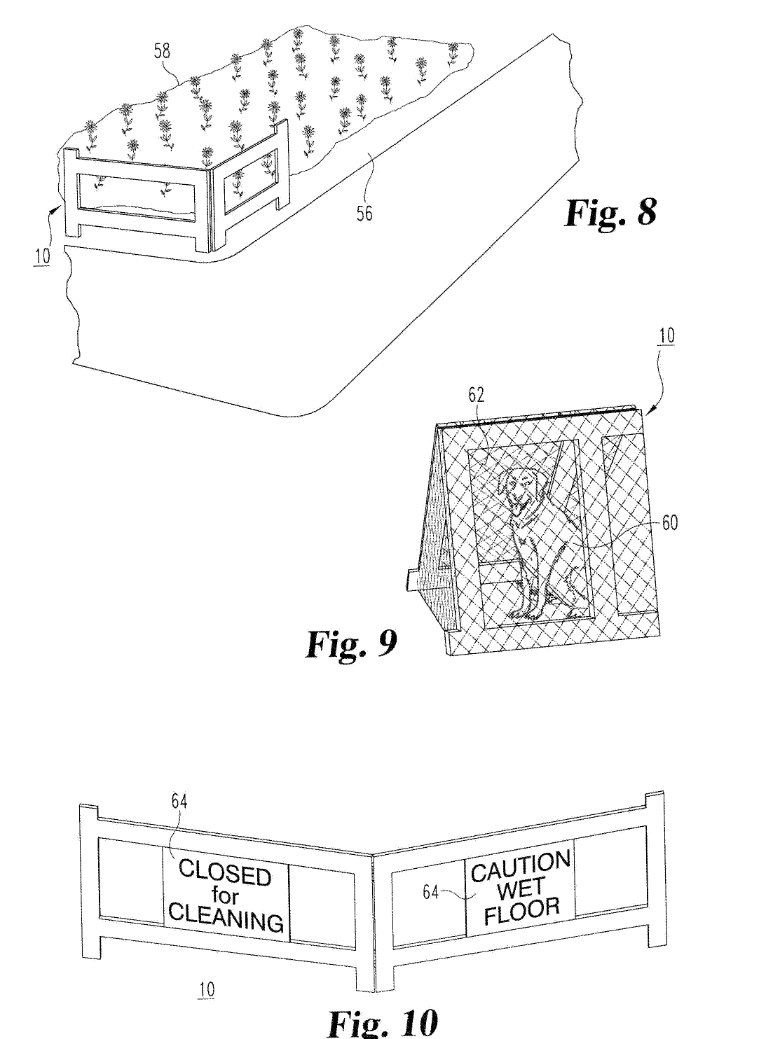

In addition to the uses previously described, system 10 can be used in numerous other ways. While some of these uses will be discussed, it is not intended to be an exhaustive list of possible uses. For example as shown in FIG. 7, system 10 can be used in conjunction with a triangular board 54 or other rigid material to create a table or desk. FIG. 8 shows the use of system 10 as landscaping to delineate the edge of a driveway 56 or garden 58. FIG. 9 shows the use of system 10 as a temporary pen for an animal, such as dog 60, when fitted with suitable mesh or containment material 62. FIG. 10 shows system 10 fitted with one or more signs 64 (via incorporated grooves or clips (not shown) to provide a notice of a condition or as a barrier to prevent access to an area or room. As other non-limiting examples (not shown), system 10 could be used to hold holiday decorations, function as a suitcase stand, or to provide a fence around trash or refuse containers. The various members of system 10 may be made to be telescopic to enable system 10 to accommodate different sized projects or needs. As can be seen in the various Figures, system 10 provides advantageous features when placed in many different positions and orientations, with its adjustability being of particular advantage.

While the disclosure has been illustrated and described in detail in the drawings and foregoing description, the same is to be considered as illustrative and not restrictive in character, it being understood that only the preferred embodiment has been shown and described and that all changes and modifications that come within the spirit of the disclosure are to be desired to be protected.

What is claimed is:

1. An adjustable material support and display system comprising:
a first assembly comprising:
a proximal member having first and second ends;
a first elongated member having a first end disposed adjacent said first end of said first member and extending substantially perpendicular to and outwardly therefrom;
a second elongated member having a first end disposed adjacent said second end of said first member and extending substantially perpendicular to and outwardly therefrom;
a distal member having a first end disposed adjacent said second end of said first elongated member and extending between said first and second elongated members such that a second end of said distal member extends beyond said second end of said second elongated member;
a second assembly comprising:
a proximal member having first and second ends;
a first elongated member having a first end disposed adjacent said first end of said first member and extending substantially perpendicular to and outwardly therefrom;
a second elongated member having a first end disposed adjacent said second end of said first member and extending substantially perpendicular to and outwardly therefrom;
a distal member having a first end disposed adjacent said second end of said first elongated member and extending between said first and second elongated members such that a second end of said distal member extends beyond said second end of said second elongated member; and
wherein said proximal member of said first assembly cooperates with said proximal member of said second assembly to form an adjustable arrangement between said first assembly and said second assembly.

2. The system of claim 1, wherein said adjustable arrangement comprises a hinge.

3. The system of claim 2, wherein said hinge has a range of approximately 0° to substantially 180°.

4. The system of claim 1, wherein said first assembly and said second assembly are mirror images of one another.

5. The system of claim 1, wherein said first assembly and said second assembly are constructed to be identical with one another.

6. The system of claim 1, wherein said first and second assemblies comprise at least one anti-skid surface.
